(19) United States
(12) Patent Application Publication
(10) Pub. No.: US 2015/0166875 A1
(43) Pub. Date: Jun. 18, 2015

(54) HYDRATABLE POLYMER SYSTEM BASED ON A CHIA DERIVED GELLING AGENT AND METHODS FOR MAKING AND USING SAME

(71) Applicant: Clearwater International, LLC, Houston, TX (US)

(72) Inventors: David Austin Bird, Houston, TX (US); Kenneth D. Shephard, Houston, TX (US)

(21) Appl. No.: 14/417,867

(22) PCT Filed: Jun. 24, 2013
(86) PCT No.: PCT/US13/47386

§ 371 Date: Jan. 28, 2015

Related U.S. Application Data
(60) Provisional application No. 61/663,040, filed on Jun. 22, 2012.

(51) Int. Cl. C09K 8/48; C09K 8/035; C09K 8/46; C09K 8/40; E21B 33/14; E21B 21/00

(52) U.S. Cl. CPC C09K 8/48; E21B 33/14; E21B 21/00; C09K 8/46; C09K 8/40; C09K 8/035

(57) ABSTRACT

A viscositying system for use in downhole cementing applications including a Chia derived thickening agent and methods for making and using the cements as well as other down hole fluids including a Chia derived thickening agent.

### RELATING APPLICATIONS

The present application claims the benefit of and priority to U.S. Provisional Patent Application Ser. No. 61/663,040, filed 22 Jun. 2012 (6/22/2012).

### BACKGROUND OF THE INVENTION

Embodiments of the present invention relates to a composition including a chia derived thickening agent and to methods for making and using same for viscosifying downhole fluids including cements, spacer fluids, and potentially other down hole fluids such as drilling fluids, fracturing fluids, stimulating fluids, production fluids and/or completion fluids.

More particularly, embodiments of the present invention relates to compositions including a chia derived thickening agent and to methods for making and using same, where the compositions may also include an effective amount of a viscosifying system including a chia derived thickening agent to increase a viscosity of downhole fluids including cements, spacer fluids, and potentially other down hole fluids such as drilling fluids, fracturing fluids, stimulating fluids, production fluids and/or completion fluids, where the chia derived thickening agent is safe and environmentally friendly.

### Description of the Related Art

Many hydratable polymers systems have been developed for use in cementing applications as the polymer increase the viscosity of a fluid as the material hydrates. While there are numerous cement thickening agents, there is still a need in the art for new thickening agents that are in the first instance water dispersible and water viscosifying, and in the second instance, environmentally benign.

### SUMMARY OF THE INVENTION

Embodiments of present invention provide cement thickening compositions including an effective amount of a chia derived hydratable thickening agent for thickening a cement for down hole use. In certain embodiments, the compositions further include an aqueous base fluid. In certain embodiments, the compositions further include an organic base fluid. In other embodiments, the compositions further include secondary hydratable thickening agents.

Embodiments of the present invention provide cement compositions for cementing subsurface wells including an effective amount of a thickening compositions, where the amount is sufficient to impart a desired viscosity to the cement compositions and where the thickening agent includes a chia derived hydratable thickening agent.

Embodiments of the present invention provide spacer fluid compositions including an effective amount of a thickening compositions, where the amount is sufficient to impart a desired viscosity to the cement compositions and where the thickening agent includes a chia derived hydratable thickening agent.

Embodiments of the present invention provide dry mix compositions for forming the aqueous spacer fluids by mixing with water, where the compositions include an effective amount of a thickening compositions, where the amount is sufficient to impart a desired viscosity to the cement compositions and where the thickening agent includes a chia derived hydratable thickening agent.

Embodiments of this invention provide methods for drilling subterranean including circulating a drilling fluid, while drilling a borehole, where the drilling fluid includes an effective amount of a thickening compositions, where the amount is sufficient to impart a desired viscosity to the cement compositions and where the thickening agent includes a chia derived hydratable thickening agent.

Embodiments of this invention provide methods for cementing subterranean including pumping a cementing composition including an effective amount of a thickening compositions, where the amount is sufficient to impart a desired viscosity to the cement compositions and where the thickening agent includes a chia derived hydratable thickening agent.

Embodiments of this invention provide methods including displacing a first fluid such as a drilling fluid, with an incompatible second fluid such as a cement slurry, in a well. The spacer fluid functions to separate the first fluid from the second fluid and to remove the first fluid from the walls of the well, where the spacer fluid includes an effective amount of a thickening compositions, where the amount is sufficient to impart a desired viscosity to the cement compositions and where the thickening agent includes a chia derived hydratable thickening agent. In drilling and completion operations, the purpose of the spacer fluid is to suspend and remove partially dehydrated/gelled drilling fluid and drill cuttings from the well bore and allow a second fluid such as completion brines, to be placed in the well bore.

### DETAILED DESCRIPTION OF THE INVENTION

The inventors have found that new hydratable polymer thickening compositions can be prepared using ground Chia (Salvia Hispanica) seeds, a common grass seed that is used as a thickening agent in the food industry, as well as consumed as a health food. The ground material is a hydrophilic endosperm that creates a gel when mixed with water. The properties of this gel are comparable to xanthan gums used in both the food and oil industry. The inventors believe that a chia derived thickening agent is ideally suited for use in downhole cement fluids and spacer fluids and may find additional application in other types of down hole fluids including drilling fluids, fracturing fluids, stimulating fluids, completion fluids, and production fluids, where increased viscosity is required and/or reduced friction is needed and where the fluids are safe and environmentally friendly. The inventors believe that their invention represent the first use of a thickening agent or viscosifying agent for water based fracturing fluids or other oil field fluids based on a chia seed derived thickening agent. Chia is a product of the Americans and is isolated from world markets, while gaur, which comes from India, is more sensitive to world markets. Chia seed is used in the food industry and is safe to consume. The inventors have found that a chia seed viscosifier may be produced using the seeds, partially ground seeds, fully ground seeds, or mixtures and combinations thereof, where the chia seed materials include polysaccharide that will viscosify water. The inventors have also found that viscosifying compositions including a chia seed viscosifying agent are well suited for used in down hole cements, spacer fluids, other down hole fluids and numerous other downhole applications, where a high viscosity, environmentally safer fluid is desired.

The present invention broadly relates to: a) viscosifying compositions including a chia seed derived thickening agent, b) cements including a viscosifying composition including a chia seed derived thickening agent, c) spacer fluids including a viscosifying composition including a chia seed derived thickening agent, and e) foamed versions of each of the fluids and compositions of a-d. Additionally the viscosifying compositions may find application in fracturing fluids, drilling fluids, completion or production fluids and foamed versions thereof.

The present invention broadly relates to cements and spacer fluids including a viscosifying composition including a chia seed derived thickening agent.

### Compositional Ranges

### Thickening Agent Compositional Ranges—Water Based Fluids

The hydratable polymer may be present in the fluid in concentrations ranging between 0.001 wt. % and about 5.0 wt. % of the aqueous fluid. In other embodiments, the range is between about 0.01 wt. % and about 4 wt. %. In yet other embodiments, the range is between about 0.1% and about 2.5 wt. %. In certain other embodiments, the range if between about 0.20 wt. % and about 0.80 wt. %.

### Thickening Agent Compositional Ranges—Oil Based Fluids

The hydratable polymer may be present in the fluid in concentrations ranging between 0.001 wt. % and about 5.0 wt. % of the oil based fluid including a base oil. In other embodiments, the range is between about 0.01 wt. % and about 4 wt. %. In yet other embodiments, the range is between about 0.1% and about 2.5 wt. %. In certain other embodiments, the range if between about 0.20 wt. % and about 0.80 wt. %

### Cross-linking System Compositional Ranges

In other embodiments, the crosslinking agents is present in a range of from about 10 ppm to about 1000 ppm of metal ion of the crosslinking agent in the hydratable polymer fluid. In some applications, the aqueous polymer solution is crosslinked immediately upon addition of the crosslinking agent to form a highly viscous gel. In other applications, the reaction of the crosslinking agent can be retarded so that viscous gel formation does not occur until the desired time.

Historically, companies in the industry have been combining borate ions and organozirconate in cross-linking systems for cross-linking CMHPG gel systems in order to show higher surface cross-linking properties. For example, U.S. Pat. No. 6,214,773 disclosed an improved high temperature, low residue viscous well treating fluid comprising: water; a hydrated galactomannan thickening agent present in said treating fluid in an amount in the range of from about 0.12% to about 0.48% by weight of said water in said treating fluid; a retarded cross-linking composition for buffering said treating fluid and cross-linking said hydrated galactomannan thickening agent comprised of a liquid solvent comprising a mixture of water, triethanolamine, a polyhydroxyl containing compound and isopropyl alcohol, an organotitanate chelate or an organozirconate chelate and aborate ion producing compound, said retarded cross-linking composition being present in said treating fluid in an amount in the range of from about 0.04% to about 1.0% by weight of water in said treating fluid; and a delayed gel breaker for causing said viscous treating fluid to break into a thin fluid present in said treating fluid in an amount in the range of from about 0.01% to about 2.5% by weight of water in said treating fluid.

The cross-linking compositions of this invention generally have a mole ratio of a borate of a borate generating compound and a transition metal alkoxide between about 10:1 and about 1:10. In certain embodiments, the mole ratio is between about 5:1 and about 1:5. In other embodiments, the mole ratio is between about 4:1 and 1:4. In other embodiments, the mole ratio is between about 3:1 and 1:3. In other embodiments, the mole ratio is between about 2:1 and 1:2. And, in other embodiments, the mole ratio is about 1:1. The exact mole ratio of the reaction product will depend somewhat on the conditions and system to which the composition is to be used as will be made more clear herein. While the cross-linking systems of this invention includes at least one cross-linking agent of this invention, the systems can also include one or more conventional cross-linking agents many of which are listed herein below.

### Fracturing Fluid Compositional Ranges

The cross-linking system of this invention is generally used in and amount between about 0.1 GAL/MBAL (gallons per thousand gallons) and about 5.0 GAL/MGAL. In certain embodiments, the cross-linking system is used in an amount between about 0.5 GAL/MGAL and about 4.0 GAL/MGAL. In other embodiments, the cross-linking system is used in an amount between about 0.7 GAL/MGAL and about 3.0 GAL/MGAL. In other embodiments, the cross-linking system is used in an amount between about 0.8 GAL/MGAL and about 2.0 GAL/MGAL. In other embodiments, the cross-linking system is used in an amount between about 1.0 GAL/MGAL and about 5.0 GAL/MGAL. In other embodiments, the cross-linking system is used in an amount between about 1.0 GAL/MGAL and about 4.0 GAL/MGAL. In other embodiments, the cross-linking system is used in an amount between about 1.0 GAL/MGAL and about 3.0 GAL/MGAL. In other embodiments, the cross-linking system is used in an amount between about 1.0 GAL/MGAL and about 2.0 GAL/MGAL.

Some fracturing jobs require added viscosity to be successful, and all fracturing jobs require reduction in friction. This chia gel could address the added viscosity and/or the friction problem inherent in fracturing treatments. Current fracturing gels and additives can be harmful to the environment. This chia Gel could be completely safe. Current fracturing gels are slurried in diesel or mineral oil. This chia gel could be slurried in water.

### Suitable Reagents

### Chia Seed

Suitable Chia seed materials include, without limitation, Salvia hispanica seed, Salvia lavandulifolia seed, Salvia columbariae seed, or mixtures and combinations thereof. These species are in the following genius: Plantae, Angiosperms, Eudicots, Asterids, Lamiales, Lamiaceae, and Salvia. In certain embodiments, the Chia seed material are used without further processing. In other embodiments, the Chia seed material is fractured or partially ground. In other embodiments, the Chia send material is fully ground.

### Other Hydratable Polymers

Suitable hydratable polymers that may be used in embodiments of the invention include any of the hydratable polysaccharides which are capable of forming a gel in the presence of at least one cross-linking agent of this invention and any other polymer that hydrates upon exposure to water or an aqueous solution capable of forming a gel in the presence of at least one cross-linking agent of this invention. For instance, suitable hydratable polysaccharides include, but are not limited to, galactomannan gums, glucomannan gums, guars, derived guars, and cellulose derivatives. Specific examples are guar gum, guar gum derivatives, locust bean gum, Karaya gum, carboxymethyl cellulose, carboxymethyl hydroxyethyl cellulose, and hydroxyethyl cellulose. Presently preferred thickening agents include, but are not limited to, guar gums, hydroxypropyl guar, carboxymethyl hydroxypropyl guar, carboxymethyl guar, and carboxymethyl hydroxyethyl cellulose. Suitable hydratable polymers may also include synthetic polymers, such as polyvinyl alcohol, polyacrylamides, poly-2-amino-2-methyl propane sulfonic acid, and various other synthetic polymers and copolymers. Other suitable polymers are known to those skilled in the art. Other examples of such polymer include, without limitation, guar gums, high-molecular weight polysaccharides composed of mannose and galactose sugars, or guar derivatives such as hydropropyl guar (HPG), carboxymethyl guar (CMG). carboxymethylhydropropyl guar (CMHPG), hydroxyethylcellulose (HEC), hydroxypropylcellulose (HPC), carboxymethylhydroxyethylcellulose (CMHEC), xanthan, scleroglucan, polyacrylamide, polyacrylate polymers and copolymers. Other examples of suitable hydratable polymers are set forth herein.

### Hydrocarbon Base Fluids

Suitable hydrocarbon base fluids for use in this invention includes, without limitation, synthetic hydrocarbon fluids, petroleum based hydrocarbon fluids, natural hydrocarbon (non-aqueous) fluids or other similar hydrocarbons or mixtures or combinations thereof. The hydrocarbon fluids for use in the present invention have viscosities ranging from about 5×10⁻⁶ to about 600×10⁻⁶ m²/s (5 to about 600 centistokes). Exemplary examples of such hydrocarbon fluids include, without limitation, polyalphaolefins, polybutenes, polyolesters, biodiesels, simple low molecular weight fatty esters of vegetable or vegetable oil fractions, simple esters of alcohols such as Exxate from Exxon Chemicals, vegetable oils, animal oils or esters, other essential oil, diesel, diesel having a low or high sulfur content, kerosene, jet-fuel, white oils, mineral oils, mineral seal oils, hydrogenated oil such as PetroCanada HT-40N or IA-35 or similar oils produced by Shell Oil Company, internal olefins (IO) having between about 12 and 20 carbon atoms, linear alpha olefins having between about 14 and 20 carbon atoms, polyalpha olefins having between about 12 and about 20 carbon atoms, isomerized alpha olefins (IAO) having between about 12 and about 20 carbon atoms, VM&P Naptha, Linpar, Parafins having between 13 and about 16 carbon atoms, and mixtures or combinations thereof.

Suitable polyalphaolefins (PAOs) include, without limitation, polyethylenes, polypropylenes, polybutenes, polypentenes, polyhexenes, polyheptenes, higher PAOs, copolymers thereof, and mixtures thereof. Exemplary examples of PAOs include PAOs sold by Mobil Chemical Company as SHF fluids and PAOs sold formerly by Ethyl Corporation under the name ETHYLFLO and currently by Albemarle Corporation under the trade name Durasyn. Such fluids include those specified as ETYHLFLO 162, 164, 166, 168, 170, 174, and 180. Well suited PAOs for use in this invention include bends of about 56% of ETHYLFLO now Durasyn 174 and about 44% of ETHYLFLO now Durasyn 168.

Exemplary examples of polybutenes include, without limitation, those sold by Amoco Chemical Company and Exxon Chemical Company under the trade names INDOPOL and PARAPOL, respectively. Well suited polybutenes for use in this invention include Amoco's INDOPOL 100.

Exemplary examples of polyolester include, without limitation, neopentyl glycols, trimethylolpropanes, pentaerythriols, dipentaerythritols, and diesters such as dioctylsebacate (DOS), diactylazelate (DOZ), and dioctyladipate.

Exemplary examples ofpetroleum based fluids include, without limitation, white mineral oils, paraffinic oils, and medium-viscosity-index (MVI) naphthenic oils having viscosities ranging from about 5×10⁻⁶ to about 600×10⁻⁶ m²/s (5 to about 600 centistokes) at 40° C. Exemplary examples of white mineral oils include those sold by Witco Corporation, Arco Chemical Company, PSI, and Penreco. Exemplary examples of paraffinic oils include solvent neutral oils available from Exxon Chemical Company, high-viscosity-index (HVI) neutral oils available from Shell Chemical Company, and solvent treated neutral oils available from Arco Chemical Company. Exemplary examples of MVI naphthenic oils include solvent extracted coastal pale oils available from Exxon Chemical Company, MVI extracted/acid treated oils available from Shell Chemical Company, and naphthenic oils sold under the names HydroCal and Calsol by Calumet and hydrogenated oils such as HT-40N and IA-35 from PetroCanada or Shell Oil Company or other similar hydrogenated oils.

Exemplary examples of vegetable oils include, without limitation, castor oils, corn oil, olive oil, sunflower oil, sesame oil, peanut oil, palm oil, palm kernel oil, coconut oil, butter fat, canola oil, rape seed oil, flax seed oil, cottonseed oil, linseed oil, other vegetable oils, modified vegetable oils such as crosslinked castor oils and the like, and mixtures thereof. Exemplary examples of animal oils include, without limitation, tallow, mink oil, lard, other animal oils, and mixtures thereof. Other essential oils will work as well. Of course, mixtures of all the above identified oils can be used as well.

### Cements

The formulations of the invention may be based on Portland cements including classes A, B, C, G, H and/or R as defined in Section 10 of the American Petroleum Institute's (API) standards. In certain embodiments, the Portland cements includes classes G and/or H, but other cements which are known in this art can also be used to advantage. For low-temperature applications, aluminous cements and Portland/plaster mixtures (for deepwater wells, for example) or cement/silica mixtures (for wells where the temperature exceeds 120° C., for example) may be used, or cements obtained by mixing a Portland cement, slurry cements and/or fly ash.

### Gases

Suitable gases for foaming the foamable, ionically coupled gel composition include, without limitation, nitrogen, carbon dioxide, or any other gas suitable for use in formation fracturing, or mixtures or combinations thereof.

### pH Modifiers

Suitable pH modifiers for use in this invention include, without limitation, alkali hydroxides, alkali carbonates, alkali bicarbonates, alkaline earth metal hydroxides, alkaline earth metal carbonates, alkaline earth metal bicarbonates, rare earth metal carbonates, rare earth metal bicarbonates, rare earth metal hydroxides, amines, hydroxylamines (NH₂OH), alkylated hydroxyl amines (NH₂OR, where R is a carbyl group having from 1 to about 30 carbon atoms or heteroatoms—O or N), and mixtures or combinations thereof. Preferred pH modifiers include NaOH, KOH, Ca(OH)₂, CaO, Na₂CO₃, KHCO₃, K₂CO₃, NaHCO₃, MgO, Mg(OH)₂ and mixtures or combinations thereof. Preferred amines include triethylamine, triproplyamine, other trialkylamines, bis hydroxyl ethyl ethylenediamine (DGA), bis hydroxyethyl diamine 1-2 dimethylcyclohexane, or the like or mixtures or combinations thereof.

### Corrosion Inhibitors

Suitable corrosion inhibitor for use in this invention include, without limitation: quaternary ammonium salts e.g., chloride, bromides, iodides, dimethylsulfates, diethylsulfates, nitrites, bicarbonates, carbonates, hydroxides, alkoxides, or the like, or mixtures or combinations thereof; salts of nitrogen bases; or mixtures or combinations thereof. Exemplary quaternary ammonium salts include, without limitation, quaternary ammonium salts from an amine and a quaternarization agent, e.g., alkylchlorides, alkylbromide, alkyl iodides, alkyl sulfates such as dimethyl sulfate, diethyl sulfate, etc., dihalogenated alkanes such as dichloroethane, dichloropropane, dichloroethyl ether, epichlorohydrin adducts of alcohols, ethoxylates, or the like; or mixtures or combinations thereof and an amine agent, e.g., alkylpyridines, especially, highly alkylated alkylpyridines, alkyl quinolines, C6 to C24 synthetic tertiary amines, amines derived from natural products such as coconuts, or the like, dialkylsubstituted methyl amines, amines derived from the reaction of fatty acids or oils and polyamines, amidoimidazolines of DETA and fatty acids, imidazolines of ethylenediamine, imidazolines of diaminocyclohexane, imidazolines of aminoethylethylenediamine, pyrimidine of propane diamine and alkylated propene diamine, oxyalkylated mono and polyamines sufficient to convert all labile hydrogen atoms in the amines to oxygen containing groups, or the like or mixtures or combinations thereof. Exemplary examples of salts of nitrogen bases, include, without limitation, salts of nitrogen bases derived from a salt, e.g.: C1 to C8 monocarboxylic acids such as formic acid, acetic acid, propanoic acid, butanoic acid, pentanoic acid, hexanoic acid, heptanoic acid, octanoic acid, 2-ethylhexanoic acid, or the like; C2 to C12 dicarboxylic acids, C2 to C12 unsaturated carboxylic acids and anhydrides, or the like; polyacids such as diglycolic acid, aspartic acid, citric acid, or the like; hydroxy acids such as lactic acid, itaconic acid, or the like; aryl and hydroxy aryl acids; naturally or synthetic amino acids; thioacids such as thioglycolic acid (TGA); free acid forms of phosphoric acid derivatives of glycol, ethoxylates, ethoxylated amine, or the like, and aminosulfonic acids; or mixtures or combinations thereof and an amine, e.g.: high molecular weight fatty acid amines such as cocoamine, tallow amines, or the like; oxyalkylated fatty acid amines; high molecular weight fatty acid polyamines (di, tri, tetra, or higher); oxyalkylated fatty acid polyamines; amino amides such as reaction products of carboxylic acid with polyamines where the equivalents of carboxylic acid is less than the equivalents of reactive amines and oxyalkylated derivatives thereof; fatty acid pyrimidines; monoimidazolines of EDA, DETA or higher ethylene amines, hexamethylene diamine (HMDA), tetramethylenediamine (TMDA), and higher analogs thereof; bisimidazolines, imidazolines of mono and polyorganic acids; oxazolines derived from monoethanol amine and fatty acids or oils, fatty acid ether amines, mono and bis amides of aminoethylpiperazine; GAA and TGA salts of the reaction products of crude tall oil or distilled tall oil with diethylene triamine; GAA and TGA salts of reaction products of dimer acids with mixtures of poly amines such as TMDA, HMDA and 1,2-diaminocyclohexane; TGA salt of imidazoline derived from DETA with tall oil fatty acids or soy bean oil, canola oil, or the like; or mixtures or combinations thereof.

### Other Additives

The drilling fluids of this invention can also include other additives as well such as scale inhibitors, carbon dioxide control additives, paraffin control additives, oxygen control additives, or other additives.

### Scale Control

Suitable additives for Scale Control and useful in the compositions of this invention include, without limitation: Chelating agents, e.g., Na, K or NH₄⁺ salts of EDTA; Na, K or NH₄⁺ salts of NTA; Na, K or NH₄⁺ salts of Erythorbic acid; Na, K or NH₄⁺ salts of thioglycolic acid (TGA); Na, K or NH₄⁻ salts of Hydroxy acetic acid; Na, K or NH₄⁺ salts of Citric acid; Na, K or NH₄⁺ salts of Tartaric acid or other similar salts or mixtures or combinations thereof. Suitable additives that work on threshold effects, sequestrants, include, without limitation: Phosphates, e.g., sodium hexamethylphosphate, linear phosphate salts, salts of polyphosphoric acid, Phosphonates, e.g., nonionic such as HEDP (hydroxythylidene diphosphoric acid), PBTC (phosphoisobutane, tricarboxylic acid), Amino phosphonates of: MEA (monoethanolamine), NH₃, EDA (ethylene diamine), Bishydroxyethylene diamine, Bisaminoethylether, DETA (diethylenetriamine), HMDA (hexamethylene diamine), Hyper homologues and isomers of HMDA, Polyamines of EDA and DETA, Diglycolamine and homologues, or similar polyamines or mixtures or combinations thereof; Phosphate esters, e.g., polyphosphoric acid esters or phosphorus pentoxide (P₂O₅) esters of: alkanol amines such as MEA, DEA, triethanol amine (TEA), Bishydroxyethylethylene diamine; ethoxylated alcohols, glycerin, glycols such as EG (ethylene glycol), propylene glycol, butylene glycol, hexylene glycol, trimethylol propane, pentaeryithrol, neopentyl glycol or the like; Tris & Tetra hydroxy amines; ethoxylated alkyl phenols (limited use due to toxicity problems), Ethoxylated amines such as monoamines such as MDEA and higher amines from 2 to 24 carbons atoms, diamines 2 to 24 carbons carbon atoms, or the like; Polymers, e.g., homopolymers of aspartic acid, soluble homopolymers of acrylic acid, copolymers of acrylic acid and methacrylic acid, terpolymers of acylates, AMPS, etc., hydrolyzed polyacrylamides, poly malic anhydride (PMA); or the like; or mixtures or combinations thereof.

### Carbon Dioxide Neutralization

Suitable additives for CO₂ neutralization and for use in the compositions of this invention include, without limitation, MEA, DEA, isopropylamine, cyclohexylamine, morpholine, diamines, dimethylaminopropylamine (DMAPA), ethylene diamine, methoxy proplyamine (MOPA), dimethylethanol amine, methyldiethanolamine (MDEA) & oligomers, imidazolines of EDA and homologues and higher adducts, imidazolines of aminoethylethanolamine (AEEA), aminoethylpiperazine, aminoethylethanol amine, di-isopropanol amine, DOW AMP-90™, Angus AMP-95, dialkylamines (of methyl, ethyl, isopropyl), mono alkylamines (methyl, ethyl, isopropyl), trialkyl amines (methyl, ethyl, isopropyl), bishydroxyethylethylene diamine (THEED), or the like or mixtures or combinations thereof.

### Paraffin Control

Suitable additives for Paraffin Removal, Dispersion, and/or paraffin Crystal Distribution include, without limitation: Cellosolves available from DOW Chemicals Company; Cellosolve acetates; Ketones; Acetate and Formate salts and esters; surfactants composed of ethoxylated or propoxylated alcohols, alkyl phenols, and/or amines; methylesters such as coconate, laurate, soyate or other naturally occurring methylesters of fatty acids; sulfonated methylesters such as sulfonated coconate, sulfonated laurate, sulfonated soyate or other sulfonated naturally occurring methylesters of fatty acids; low molecular weight quaternary ammonium chlorides of coconut oils soy oils or C 10 to C24 amines or monohalogenated alkyl and aryl chlorides; quanternary ammonium salts composed of disubstituted (e.g., dicoco, etc.) and lower molecular weight halogenated alkyl and/or aryl chlorides; gemini quaternary salts of dialkyl (methyl, ethyl, propyl, mixed, etc.) tertiary amines and dihalogenated ethanes, propanes, etc. or dihalogenated ethers such as dichloroethyl ether (DCEE), or the like; gemini quaternary salts of alkyl amines or amidopropyl amines, such as cocoamidopropyldimethyl, bis quaternary ammonium salts of DCEE; or mixtures or combinations thereof. Suitable alcohols used in preparation of the surfactants include, without limitation, linear or branched alcohols, specially mixtures of alcohols reacted with ethylene oxide, propylene oxide or higher alkyleneoxide, where the resulting surfactants have a range of HLBs. Suitable alkylphenols used in preparation of the surfactants include, without limitation, nonylphenol, decylphenol, dodecylphenol or other alkylphenols where the alkyl group has between about 4 and about 30 carbon atoms. Suitable amines used in preparation of the surfactants include, without limitation, ethylene diamine (EDA), diethylenetriamine (DETA), or other polyamines. Exemplary examples include Quadrols, Tetrols, Pentrols available from BASF. Suitable alkanolamines include, without limitation, monoethanolamine (MEA), diethanolamine (DEA), reactions products of MEA and/or DEA with coconut oils and acids.

### Oxygen Control

The introduction of water downhole often is accompanied by an increase in the oxygen content of downhole fluids due to oxygen dissolved in the introduced water. Thus, the materials introduced downhole must work in oxygen environments or must work sufficiently well until the oxygen content has been depleted by natural reactions. For system that cannot tolerate oxygen, then oxygen must be removed or controlled in any material introduced downhole. The problem is exacerbated during the winter when the injected materials include winterizers such as water, alcohols, glycols, Cellosolves, formates, acetates, or the like and because oxygen solubility is higher to a range of about 14-15 ppm in very cold water. Oxygen can also increase corrosion and scaling. In CCT (capillary coiled tubing) applications using dilute solutions, the injected solutions result in injecting an oxidizing environment (O₂) into a reducing environment (CO₂, H₂S, organic acids, etc.).

Options for controlling oxygen content includes: (1) de-aeration of the fluid prior to downhole injection, (2) addition of normal sulfides to product sulfur oxides, but such sulfur oxides can accelerate acid attack on metal surfaces, (3) addition of erythorbates, ascorbates, diethylhydroxyamine or other oxygen reactive compounds that are added to the fluid prior to downhole injection; and (4) addition of corrosion inhibitors or metal passivation agents such as potassium (alkali) salts of esters of glycols, polyhydric alcohol ethyloxylates or other similar corrosion inhibitors. Exemplary examples oxygen and corrosion inhibiting agents include mixtures of tetramethylene diamines, hexamethylene diamines, 1,2-diaminecyclohexane, amine heads, or reaction products of such amines with partial molar equivalents of aldehydes. Other oxygen control agents include salicylic and benzoic amides of polyamines, used especially in alkaline conditions, short chain acetylene diols or similar compounds, phosphate esters, borate glycerols, urea and thiourea salts of bisoxalidines or other compound that either absorb oxygen, react with oxygen or otherwise reduce or eliminate oxygen.

### Salt Inhibitors

Suitable salt inhibitors for use in the fluids of this invention include, without limitation, Na Minus-Nitrilotriacetamide available from Clearwater International, LLC of Houston, Tex.

### Cement or Cementing Compositions

The high density cement compositions of this invention are generally slurries including water, a gelling system including a thickening compositions including a chia derived thickening agent, and optionally hydraulic cement system, where the hydraulic cement system includes a weighting or densifying subsystem including at least one metal silicon alloy having a density of at least 6.0 g/cm³.

The fluid compositions of this invention are particularly well suited as high viscosity drilling fluids and drilling muds.

Dispersants and viscosifiers maybe added to provide additional rheology control. An example of common a dispersant chemistry is naptoline sulfonates Dispersant.

In utilizing the cementing compositions for sealing a subterranean formation, a specific quantity of cement slurry is prepared and introduced through the well bore into the formation to be treated. The cement slurry is particularly useful in cementing the annular void space (annulus) between a casing or pipe in the borehole. The cement slurry is easily pumped downwardly through the pipe and then outward and upwardly into the annular space on the outside of the pipe. Upon solidifying, the cement slurry sets into a high strength, high density, concrete form or structure.

When the cement slurry is utilized in a high temperature environment, such as deep oil wells, set time retarders may be utilized in the cement composition in order to provide ample fluid time for placement of the composition at the point of application.

A particularly desirable use of the high density cement compositions of this invention is in oil field applications, where borehole conditions of a well limit the interval in which high density cement may be used for the purpose of controlling a pressurized formation. An example of such a use would be when a weak formation is separated from an over-pressured formation by relatively short intervals.

Embodiments of the hydraulic cement compositions of this invention include from about 1 wt. % to about 20 wt. % of the viscosifying composition including a chia derived thickening agent.

Embodiments of hydraulic cement compositions of this invention may also include a retarder in the amount of 0.1-3% (dry weight) based on the weight of cement. The chemical composition of retarders are known in the art. They may be based on lignosulfonates, modified lignosulfonates, polyhydroxy carboxylic acids, carbohydrates, cellulose derivatives or borates. Some of the retarders will also act as thinners in the hydraulic cement slurry and when such retarders are used the dosage of thinners may be reduced.

Embodiments of hydraulic cement compositions of this invention may also include a thinner or dispersant in an amount of 0.7 to 6% (dry weight) based on the weight of the cement. Thinners additives which are known as plastisizers or superplastisizers in cement based systems can be used. These are well-known additives which may be based on lignosulfonate, sulfonated napthaleneformaldehyde or sulfonated melamineformaldehyde products.

Embodiments of hydraulic cement compositions of this invention may also include 0.1-4% (dry weight) of a fluid loss additive based on the weight of the cement. Known fluid loss additives may be based on starch or derivates of starch, derivates of cellulose such as carboxymethylcellulose, methylcellulose or ethylcellulose or synthetic polymers such as polyacrylonitrile or polyacrylamide may be used.

Cement slurries which are used at high well temperature may also include 10-35% silica flour and/or silica sand based on the weight of the cement.

Both fresh water and sea water may be used in the hydraulic cement slurry of the present invention.

If necessary, accelerators may be incorporated into the cement slurry in order to adjust the setting time.

It has surprisingly been found that the high density hydraulic cement compositions of the present invention are gas tight, show very little tendency of settling and have low strength retrogression. Thus the content of high density filler material and the content of silica sand or silica flour may be increased above the conventional levels without affecting the plasticity of the cement slurries while the tendency of settling is strongly reduced.

In certain embodiments, the high density cement compositions of this invention have a density of about 21 lbs/gallon.

In certain embodiments, the cement may include a weighting material including a metal silicon alloy, mixtures of metal silicon alloys, iron, steel, barite, hematite, other iron ores, tungsten, tin, manganese, manganese tetraoxide, calcium carbonate, illmenite, sand or mixtures thereof. The relative amount and type of the two weighting materials maybe selected to produce desired properties of the cementing composition.

### Methods of Cementing

The overall process of cementing an annular space in a wellbore typically includes the displacement of drilling fluid with a spacer fluid or preflushing medium which will further assure the displacement or removal of the drilling fluid and enhance the bonding of the cement to adjacent structures. For example, it is contemplated that drilling fluid may be displaced from a wellbore, by first pumping into the wellbore a spacer fluid according to the present invention for displacing the drilling fluid which in turn is displaced by a cement composition or by a drilling fluid which has been converted to cement, for instance, in accordance with the methods disclosed in U.S. Pat. No. 4,883,125, the entire disclosure is incorporated by reference due to the action of the last paragraph of the specification. The spacer fluid and the cements include a viscosifying composition including a chia derived thickening agent.

In other embodiments, the spacer compositions of this invention (1) provide a buffer zone between the drilling fluid being displaced and the conventional cement slurry following the spacer fluid, (2) enhance the bonding between the conventional cement slurry and the surfaces of the borehole and casing, and (3) set to provide casing support and corrosion protection.

In other embodiments of the present invention, the spacer fluid may comprise, in combination, water, a viscosifying composition including a chia derived thickening agent, styrene-maleic anhydride copolymers (SMA) as a dispersant with or without anionic and/or nonionic water wetting surfactants, and optionally a secondary viscosifying materials such as HEC (hydroxymethyl cellulose), CMHEC (carboxymethylhydroxyethyl cellulose), PHPA (partially hydrolyzed polyacrylamide), bentonite, attapulgite, sepiolite and sodium silicate and optionally a weighting system to form a rheologically compatible medium for displacing drilling fluid from the wellbore.

In other embodiment a of the present invention, the spacer fluid comprises SMA, bentonite, welan gum, surfactant and a weighting agent. In other embodiments, the spacer fluid according to the fourth embodiment of the present invention comprises a spacer dry mix which includes: 1) 10 wt. % to 50 wt. % by weight of SMA as a dispersant; 2) 40 wt. % to 90 wt. % by weight of bentonite as a suspending agent; 3) 1 wt. % to 20 wt. % welan gum as a pseudoplastic, high efficiency viscosifier tolerant to salt and calcium, available from Kelco, Inc. under the trade name BIOZAN™; 4) 0.01 gal per bbl to 10.0 gal per bbl of aqueous base spacer of an ethoxylated nonylphenol surfactant having a mole ratio of ethylene oxide to nonylphenol ranging from 1.5 to 15, available from GAF under the trade name IGEPAL; 5) 20 wt. % to 110 wt. % of a weighting system including at least one metal silicon alloy having a density greater than or equal to about 6.0 g/cm³. In certain embodiments, the weighting agent will be added to the spacer fluid in an amount to give the spacer fluid a density equal to or greater than the density of the drilling fluid and less than or equal to the density of the cement slurry.

In well cementing operations such as primary cementing, a cement slurry is pumped into the annulus between a string of casing disposed in the well bore and the walls of the well bore for the intended purpose of sealing the annulus to the flow of fluids through the well bore, supporting the casing and protecting the casing from corrosive elements in the well bore. The drilling fluid present in the annulus partially dehydrates and gels as it loses filtrate to the formation. The presence of this partially dehydrated/gelled drilling fluid in the annulus is detrimental to obtaining an adequate cement bond between the casing and the well bore. As the casing becomes more eccentric, the removal process becomes more difficult. The drilling fluids and the cements include a viscosifying composition including a chia derived thickening agent.

In order to separate the cement slurry from the drilling fluid and remove partially dehydrated/gelled drilling fluid from the walls of the well bore ahead of the cement slurry as it is pumped, a spacer fluid is inserted between the drilling fluid and the cement slurry. The spacer fluid prevents contact between the cement slurry and drilling fluid and it is intended to possess rheological properties which bring about the removal of partially dehydrated/gelled drilling fluid from the well bore. However, virtually all elements of the downhole environment work against this end. Fluid loss from the drilling fluid produces localized pockets of high viscosity fluid. At any given shear rate (short of turbulent flow) the less viscous spacer fluid will tend to channel or finger through the more viscous drilling fluid. At low shear rates, the apparent viscosity of most cement and spacer fluids is lower than that of the high viscosity drilling fluid in localized pockets. To overcome this, the cement and spacer fluids are pumped at higher rates so that the fluids are at higher shear rates and generally have greater apparent viscosities than the drilling fluid. Drag forces produced by the drilling fluid upon filter cake are also increased. Unfortunately, the pump rates that are practical or available are not always sufficient to effectively displace and remove drilling fluid from the well bore prior to primary cementing.

Displacement of the drilling fluid is hindered by the fact that the pipe is generally poorly centered causing an eccentric annulus. In an eccentric annulus, the displacing spacer fluid tends to take the path of least resistance. It travels or channels through the wide side of the eccentric annulus where the overall shear level is lower. Since the cement and spacer fluid travel faster up the wide side of the annulus, complete cement coverage may not result before completion of the pumping of a fixed volume. Also, since the flow path will generally spiral around the pipe, drilling fluid pockets are often formed.

The displacement of drilling fluid from well bore washouts is also a problem. When the velocity (shear rate) and relative shear stress of the cement and spacer fluid are lowered due to encountering an enlarged well bore section, it is difficult for the spacer fluid to displace the drilling fluid. The cross-sectional area in enlarged sections of a well bore can be several orders of magnitude greater than the predominate or designed annulus. Fluid flow through those sections is at much lower shear rates and generally the annulus is also more eccentric since the well bore diameter is often outside the maximum effective range of casing centralizers.

Another problem which adversely affects drilling fluid displacement is spacer fluid thermal thinning A high degree of thermal thinning normally limits available down hole viscosity, particularly at elevated temperatures and low shear rates. In that situation, adequate viscosity at the lower shear rates can often not be obtained because the spacer fluid at the surface would be too viscous to be mixed or pumped. Even a very viscous spacer fluid exhibits relatively little viscosity at low shear rates and elevated temperatures.

Typically, one or more of the above mentioned rheological or other factors are working against efficient drilling fluid displacement. As a result, pockets of non-displaced drilling fluid are generally left within the annulus at the end of displacement. As mentioned, high displacement rates would help many of these problems, but in most field applications pump capacity and formation fracture gradients limit the displacement rates to less than those required. Even when relatively high pump rates can be utilized, cement evaluation logs typically show a good cement sheath only in areas of good centralization and normal well bore diameter.

Another problem involves the lack of solids suspension by spacer fluids. The thermal thinning and reduced low shear rate viscosity exhibited by many spacer fluids promotes sedimentation of solids. Until a spacer fluid develops enough static gel strength to support solids, control of sedimentation is primarily a function of low shear rate viscosity. In deviated or horizontal well bores, solids support is much more difficult and at the same time more critical. The more nearly horizontal the well bore is, the shorter the distance for coalescence. As a result, high density solids can quickly build-up on the bottom of the well bore.

An ideal spacer fluid would have a flat rheology, i.e., a 300/3 ratio approaching 1. It would exhibit the same resistance to flow across a broad range of shear rates and limit thermal thinning, particularly at low shear rates. A 300/3 ratio is defined as the 300 rpm shear stress divided by the 3 rpm shear stress measured on a Chandler or Fann Model 35 rotational viscometer using a B1 bob, an R1 sleeve and a No. 1 spring. The greater the resultant slope value, the more prone the spacer fluid is to channeling in an eccentric annulus; 300/3 ratios of 2 to 6 are achieved by the spacer fluid compositions of this invention. As a result, the compositions are better suited for drilling fluid displacement than prior art spacer fluids. The spacer fluids of this invention have relatively flat rheologies and are not impacted by eccentric annuli since they exhibit nearly the same resistance to flow across the whole annulus. Most prior art spacers exhibit a 300/3 ratio of 8-10.

By the present invention, improved spacer fluids are provided which have excellent compatibility with treating fluids such as cement slurries, drilling fluids and other completion fluids. The spacer fluids also possess the ability to suspend and transport solid materials such as partially dehydrated/gelled drilling fluid and filter cake solids from the well bore. Further, the relatively flat rheology spacer fluids of this invention possess the ability to maintain nearly uniform fluid velocity profiles across the well bore annulus as the spacer fluids are pumped through the annulus, i.e., the spacer fluids are pseudo-plastic with a near constant shear stress profile.

A dry mix composition of this invention for forming an aqueous, high density spacer fluid comprises a hydrous magnesium silicate clay, silica, an organic polymer and a weighting system including at least one metal silicon alloy having a density of at least 6.0. The hydrous magnesium silicate clay may include sepiolite and/or attapulgite.

Various forms of silica may be used such as fumed silica and colloidal silica. Fumed silica is preferred for use in the dry mix composition of this invention. As will be described further, colloidal silica is preferably used in the spacer compositions which are prepared by directly mixing the individual components with water.

The organic polymer may be welan gum, xanthan gum, galactomannan gums, succinoglycan gums, scleroglucan gums, cellulose and its derivatives, e.g., HEC, or mixtures and combinations thereof.

The dry mix compositions and/or the aqueous spacer fluids may also include a dispersing agent, a surfactant, and a weighting material. The dispersant improves compatibility of fluids which would otherwise be incompatible. The surfactant improves bonding and both the dispersant and surfactant aid in the removal of partially dehydrated/gelled drilling fluid. The viscosity of the spacer fluid is increased to a desired value by the viscosifying agent.

Various dispersing agents can be utilized in the compositions of this invention. However, preferred dispersing agents are those selected from the group consisting of sulfonated styrene maleic anhydride copolymer, sulfonated vinyl-toluene maleic anhydride copolymer, sodium naphthalene sulfonate condensed with formaldehyde, sulfonated acetone condensed with formaldehyde, ligno-sulfonates and interpolymers of acrylic acid, allyloxybenzene sulfonate, allyl sulfonate and non-ionic monomers. Generally, the dispersing agent is included in the dry mix composition in an amount in the range of from about 0.5% to about 50% by weight of the composition. It is included in the aqueous spacer fluid in an amount in the range of from about 0.05% to about 3% by weight of water in the aqueous spacer fluid composition (from about 0.1 pounds to about 10 pounds per barrel of spacer fluid). The dispersant can be added directly to the water if in liquid or solid form or included in the dry mix composition if in solid form.

While various water-wetting surfactants can be used in the compositions, nonylphenol ethoxylates, alcohol ethoxylates and sugar lipids are generally preferred. When used, the surfactant is included in the spacer fluid in an amount which replaces up to about 20% of the water used, i.e., an amount in the range of from about 0.1 gallon to about 10 gallons per barrel of spacer fluid when the surfactant is in the form of a 50% by weight aqueous concentrate. The surfactant is normally added directly to the water used or to the aqueous spacer fluid.

Other components can advantageously be included in the spacer fluids of this invention in relatively small quantities such as salts, e.g., ammonium chloride, sodium chloride and potassium chloride.

As mentioned, the spacer fluids of this invention are pseudo-plastic fluids with near constant shear stress profiles, i.e., 300/3 ratios of from about 2 to about 6. This property of the spacer fluids of this invention is particularly important when the spacer fluids are utilized in primary cementing operations. The property allows the spacer fluids to maintain nearly uniform fluid velocity profiles across a well bore annulus as the spacer fluids followed by cement slurries are pumped into the annulus. The nearly uniform fluid velocity profile brings about a more even distribution of hydraulic force impinging on the walls of the well bore thereby enhancing the removal of partially dehydrated/gelled drilling fluid and solids from the well bore. This property of the spacer fluid is particularly important in applications where the casing being cemented is located eccentrically in the well bore (an extremely probable condition for highly deviated well bores).

In carrying out the methods of the present invention, a first fluid is displaced with an incompatible second fluid in a well bore utilizing a spacer fluid of the invention to separate the first fluid from the second fluid and to remove the first fluid from the well bore. In primary cementing applications, the spacer fluid is generally introduced into the casing or other pipe to be cemented between drilling fluid in the casing and a cement slurry. The cement slurry is pumped down the casing whereby the spacer fluid ahead of the cement slurry displaces drilling fluid from the interior of the casing and from the annulus between the exterior of the casing and the walls of the well bore. The spacer fluid prevents the cement slurry from contacting the drilling fluid and thereby prevents severe viscosification or flocculation which can completely plug the casing or the annulus. As the spacer fluid is pumped through the annulus, it aggressively removes partially dehydrated/gelled drilling fluid and filter cake solids from the well bore and maintains the removed materials in suspension whereby they are removed from the annulus. As mentioned above, in primary cementing applications, the spacer fluid preferably includes a surfactant whereby the surfaces within the annulus are water-wetted and the cement achieves a good bond to the surfaces.

The cement composition of this invention may also include hydraulic binders and reinforcing particles. The flexible particles include materials having a Young's modulus of less than 5000 mega Pascals (Mpa). In certain embodiments, the flexible particles have a Young's modulus of less than 3000 Mpa, while in other embodiments, the flexible particles have a Young's modulus of less than 2000 Mpa. In certain embodiments, the elasticity of these particles is at least four times greater than that of cement and more than thirteen times that of the silica usually used as an additive in oil well cements. In certain embodiments, the flexible particles are added to the cementing compositions of the invention have low compressibility. In certain embodiments, the materials are more compressible than rubbers, in particular with a Poisson ratio of less than 0.45. In other embodiments, the Poisson ratio is less than 0.4. However, materials which are too compressible, with a Poisson ratio of less than 0.3 may result in inferior behavior.

The reinforcing particles are generally insoluble in an aqueous medium which may be saline, and they must be capable of resisting a hot basic medium since the pH of a cementing slurry is generally close to 13 and the temperature in a well is routinely higher than 100° C.

In certain embodiments, the flexible particles are isotropic in shape. Spherical or near spherical particles may be synthesized directly, but usually the particles are obtained by grinding such as by cryo-grinding. The average particle size ranges from about 80 μm to about 600 μm. In other embodiments, the average particle size ranges from about 100 μm to about 500 μm. Particles which are too fine, also particles which are too coarse, are difficult to incorporate into the mixture or result in pasty slurries which are unsuitable for use in an oil well.

Particular examples of materials which satisfy the various criteria cited above are thermoplastics (polyamide, polypropylene, polyethylene, . . . ) or other polymers such as styrene divinylbenzene or styrene butadiene (SBR).

In addition to flexible particles and weighting agents of this invention, the cementing compositions of the invention comprise an hydraulic binder, in general based on Portland cement and water. Depending on the specifications regarding the conditions for use, the cementing compositions can also be optimized by adding additives which are common to the majority of cementing compositions, such as suspension agents, dispersing agents, anti-foaming agents, expansion agents (for example magnesium oxide or a mixture of magnesium and calcium oxides), fine particles, fluid loss control agents, gas migration control agents, retarders or setting accelerators.

The formulations of the invention may be based on Portland cements including classes A, B, C, G, H and/or R as defined in Section 10 of the American Petroleum Institute's (API) standards. In certain embodiments, the Portland cements includes classes G and/or H, but other cements which are known in this art can also be used to advantage. For low-temperature applications, aluminous cements and Portland/plaster mixtures (for deepwater wells, for example) or cement/silica mixtures (for wells where the temperature exceeds 120° C., for example) may be used, or cements obtained by mixing a Portland cement, slurry cements and/or fly ash.

The water used to constitute the slurry is preferably water with a low mineral content such as tap water. Other types of water, such as seawater, can possibly be used but this is generally not preferable.

These particles with low density with respect to the cement can affect the flexibility of the system, since adding flexible particles produces cements with a lower Young's modulus, while producing low permeability and better impact resistance.

The mechanical properties of the compositions comprising flexible particles of the invention are remarkable, rendering them particularly suitable for cementing in areas of an oil well which are subjected to extreme stresses, such as perforation zones, junctions for branches of a lateral well or plug formation.

### EXPERIMENTS OF THE INVENTION

### Example 1

This example illustrates the viscosifying eagents of properties of milled chia seed in fresh water and cement slurries. Milled Chia Seeds mixed into cement slurries at the rate of 5 lb Milled Chia per sack of cement were found to increase viscosity of the slurry.

### Discussion

Milled Chia Seed acts as a strong viscosifier in water. It is found to be an equally strong viscosifier in cement. Tests were performed using 5 lb Milled Chia per sack of cement, 7.5 lb Milled Chia per sack of cement and 10 lb Milled Chia per sack of cement. 7.5 and 10 lb/sk resulted in slurries that are too viscous to mix.

TABLE 1
Test Slurry Class “G” Cement CD-110 Including Milled Chia Seeds
Clear Air 500 Mixed to 15.80 ppg

| | gal/sk | | lb/sk | | | | | | | | | | | |
|---|---|---|---|---|---|---|---|---|---|---|---|---|---|---|
| % | Clear | % | Milled | Test | | | | | | | | Fluid | | |
| CD- | Air | CR- | Chia | Temp | 300 | 200 | 100 | 60 | 30 | 6 | 3 | Loss | % Free | TTT time |
| 110 | 500 | 225 | Seeds^{a} | (° F.) | rpm | rpm | rmp | rmp | rmp | rmp | rmp | cc/30 min | Water | to 70 Bc |
| 0.5 | 0.02 | 0 | 0 | RT | 13 | 9 | 4 | 2 | 1 | 0.1 | 0.1 | | | |
| | | | | 150° F. | 9 | 6 | 3 | 2 | 1 | 0.2 | 0.1 | 551 | 1.04 | |
| 0.5 | 0.02 | 0 | 5 | RT | 96 | 72 | 44 | 32 | 26 | 19.4 | 8.2 | | | |
| | | | | 150° F. | 71 | 51 | 32 | 21 | 13 | 3.7 | 2.6 | 423 | 8 | |
| 0.5 | 0.02 | 0.1 | 0 | RT | 23 | 15 | 7 | 4 | 2 | 0.2 | 0.1 | | | |
| | | | | 150° F. | 10 | 6 | 3 | 1 | 0 | 0 | 0 | 424 | 11.2 | 08:25:00 |
| 0.5 | 0.02 | 0.1 | 5 | RT | 320 | 300 | 214 | 176 | 152 | 69.6 | 55 | | | |
| | | | | 150° F. | 322 | 254 | 172 | 132 | 96 | 45.8 | 32.4 | 131 | 0 | 31:38:00 |
| 0.5 | 0.02 | n/a | 7.5 | RT | 191 | 138 | 83 | 63 | 58 | 26.5 | 21.2 | | | |

| | | | | | |
|---|---|---|---|---|---|
| | | | | 150° F. | TOO VISCOUS TO MEASURE |
| 0.2 | 0.02 | n/a | 10 | RT | TOO VISCOUS TO MIX |
| | | | | 150° F. | TOO VISCOUS TO MIX |

^{a}Measured Density of Milled Chia Seeds = 1.9975 g/cm³

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

1. A cement composition comprising:
water;
a hydraulic cement; and
a viscosifying system including a chia derived thickening agent, where the viscosifying system increases the density of the composition, while maintaining other properties including at least gas tight sealing, low tendency to segregate, and/or reduced high temperature cement strength retrogression.

2. The composition of claim 1, further including:
a gelling agent including oxides of antimony, zinc oxide, barium oxide, barium sulfate, barium carbonate, iron oxide, hematite, other irons ores and mixtures thereof,
a weighting system including a metal silicon alloy, a mixture of metal silicon alloys, iron, steel, barite, hematite, other iron ores, tungsten, tin, manganese, manganese tetraoxide, calcium carbonate, illmenite, sand or mixtures thereof, where the weighting system comprises a powder, a shot, or mixtures and combinations thereof,
a dispersant, and/or
a fluid loss control additive.

3. The composition of claim 1, wherein the viscosifying system is present in an amount between 1 wt. % and 20 wt. %.

4. The composition of claim 1, wherein the viscosifying system is present in an amount between 1 wt. % and 15 wt. %.

5. The composition of claim 1, wherein the viscosifying system is present in an amount between 1 wt. % and 10 wt. %.

6. The composition of claim 1, wherein the viscosifying system is present in an amount between 1 wt. % and 5 wt. %.

7. The composition of claim 1, wherein the hydraulic cement comprises:
a Portland cement present in an amount of up to about 100 parts by weight of the composition; and
the viscosifying system is present in an amount between about 1 part to about 20 parts by weight of the composition, and
the water is present in an amount of up to about 80 parts by weight of the composition.

8. The composition of claim 7, wherein the viscosifying system is present in an amount between about 1 part to about 15 parts by weight of the composition.

9. The composition of claim 7, wherein the viscosifying system is present in an amount between about 1 part to about 10 parts by weight of the composition.

10. The composition of claim 7, wherein the viscosifying system is present in an amount between about 1 part to about 5 parts by weight of the composition.

11. The composition of claim 7, further comprising:
a weighting agent present in an amount up to about 200 parts by weight of the composition and comprising a metal silicon alloy, iron, steel, barite, hematite, other iron ores, tungsten, tin, manganese, manganese tetraoxide, calcium carbonate, illmenite, sand or mixtures thereof, where the weighting system comprises a powder, a shot, or mixtures and combinations thereof;
a dispersing agent;
a gelling agent; and/or
a fluid loss control additive.

12. A method of cementing in an annulus between a well casing and a borehole comprising placing in the annulus a cementitious composition comprising:
water;
a hydraulic cement; and
a viscosifying system including a chia derived thickening agent, where the system is present in an amount between about 1 to 20 parts by weight of the composition.

13. The method of claim 12, wherein the composition further comprises:
a gelling agent including oxides of antimony, zinc oxide, barium oxide, barium sulfate, other irons ores or mixtures and combinations thereof;
a weighting system including a metal silicon alloy, iron, steel, barite, hematite, other iron ores, tungsten, tin, manganese, manganese tetraoxide, calcium carbonate, illmenite, sand or mixtures thereof, where the weighting system comprises a powder, a shot, or mixtures and combinations thereof;
a dispersing agent; and/or
a fluid loss control additive.

14. The method of claim 12, wherein the viscosifying system is present in an amount between about 1 part to about 15 parts by weight of the composition.

15. The method of claim 12, wherein the viscosifying system is present in an amount between about 1 part to about 10 parts by weight of the composition.

16. The method of claim 12, wherein the viscosifying system is present in an amount between about 1 part to about 5 parts by weight of the composition.

17. A downhole fluid composition comprising:
a base fluid, and
an effective amount of a viscosifying system including a chia derived thickening agent, where the effective amount is between about 1 to 20 wt. %.

18. (canceled)

19. (canceled)

20. (canceled)

21. The fluid of claim 17, wherein the fluid is a drilling fluid, a spacer fluid, a production fluid, or a completion fluid, and the base fluid is an aqueous base fluid or an organic base fluid.

22. A method comprising:
circulating a downhole fluid into an oil and/or gas well, where the downhole fluid includes a base fluid and an effective amount of a viscosifying system including a chia derived thickening agent, where the effective amount between about 1 wt. % and about 20 wt. %.

23. A method for changing fluids in a subterranean well comprising:
displacing a first fluid in the well with a spacer fluid, and
displacing the spacer fluid in the well with a second fluid,
where the first fluid and spacer fluid are incapable and the spacer fluid and the second fluid are incompatible and the spacer fluid includes an effective amount of a viscosifying system including a chia derived thickening agent, where the effective amount between about 1 wt. % to 20 wt %.
